(19) United States
(12) Patent Application Publication
(10) Pub. No.: US 2002/0046059 A1
(43) Pub. Date: Apr. 18, 2002

(54) Product consignment management device and product consignment management method for call sales

(75) Inventor: Kenji Tsumura, Saga-ken (JP)

Correspondence Address: JORDAN AND HAMBURG LLP, 122 EAST 42ND STREET, SUITE 4000, NEW YORK, NY, 10168, US

(73) Assignee: Kentop Corporation, Saga-shi (JP)

(21) Appl. No.: 09/915,730

(22) Filed: Jul. 26, 2001

(30) Foreign Application Priority Data
Aug. 11, 2000 (JP) 2000-244548

(51) Int. Cl. G06F 17/60

(52) U.S. Cl. 705/2

(57) ABSTRACT

There are provided a product consignment management device and a product consignment management method in the field of call sales for managing product consignment so that a product is efficiently consumed before its expiry date. An amount of a product consumed by each customer and a call cycle are input using an input means 11 and stored in storage means 12. Standard deviation calculation means 13 acquires both the amount consumed and the call cycle from the storage means 12 and calculates the standard deviation S of the amount of product consumed by all customers over a predetermined period. This is then stored in the storage means 12. A rank setting means 14 acquires the standard deviation S from the storage means 12 and sets an expiry date rank for a product to be consigned to a customer based on this standard deviation S. The set expiry date rank is then output using an output means 15.

### BACKGROUND OF THE INVENTION

1. Field of the Invention

The present invention relates to a product consignment management device and a product consignment management method for managing product consignment so that a product is efficiently consumed before its expiry date in the field of call sales of medical supplies and various other products.

2. Description of the Related Art

In the field of call sales of medical supplies and the like, conventionally, what is known as a “use-now-pay-later” system (i.e. the customer pays later for the amount used) has been used in which a medicine chest containing several types of medicines having various effects is delivered and consigned to a customer. After an appropriate time has passed, a call sales operator (referred to below as a salesperson) visits the customer and receives payment from the customer for those medicines that the customer has used from the medicine chest and also replenishes the supplies of the used medicines.

In this type of use-now-pay-later system, medicines in the medicine chest that have not yet been used and whose expiry date is approaching are either replaced free of charge with items with a later expiry date or given back. For example, if the contents of the medicine chest are as shown in FIG. 5(a) at the time the salesperson calls on the customer (at a call cycle of 3 months with the present date being June, 2000), then since the next time the salesperson calls will be in September, 2000, the medicine with the expirydate of August, 2000 will have reached its expiry date one month prior to the next call.

Naturally, because it is not possible to leave medicines that have gone beyond their expiry date with a customer, as is shown in FIG. 5(b), the medicine having the expiry date of August, 2000 is replaced with medicine having an expiry date of September, 2001. The medicine having the expiry date of August, 2000 recovered from the customer is placed with the salesperson's stock. If this medicine is left in the salesperson's stock it will become defective stock in 2 months and thus what is known as product rotation is performed.

The aim of product rotation is to enable a product to be consumed before it reaches its expiry date. A product with a near expiry date is consigned to a customer who uses a large amount of product at a comparatively stable rate of consumption while a product with a distant expiry date is consigned to a customer who uses a small amount of product. Moreover, if one salesperson has a surplus stock of a product with a near expiry date, the product is passed to another salesperson who sells a comparatively greater quantity of the product, and the salesperson is entrusted with disposing of the product.

In the field of call sales, in order to increase the efficiency of consumption of a product, it is of the utmost importance that defective stock is reduced. However, conventionally, when a salesperson visits a customer, the salesperson inspects the products and collects those whose expiry date is imminent at that point so that the product rotation is carried out at the discretion of each salesperson. Accordingly, when there is a large amount of customer stock, because the product rotation is only performed at the salesperson level, defective stock arises when the product cannot be completely processed at the salesperson level.

### SUMMARY OF THE INVENTION

Therefore, there are provided in the present invention a product consignment management device and a product consignment management method for use in call sales for managing product rotation so that a product is efficiently consumed before its expiry date.

The consignment management device of the present invention for managing consignment of a product that is delivered and consigned to a customer in the field of call sales comprises: means for inputting an amount of product consumed by each the customer and a call cycle of the customer; first storage means for storing the input consumed amount; second storage means for storing the input call cycle; means for acquiring both the consumed amount from the first storage means and the call cycle from the second storage means and calculating a standard deviation of an amount of the consumed product over a predetermined period by all customers; third storage means for storing the calculated standard deviation; means for acquiring the standard deviation from the third storage means and setting an expiry date rank for the product to be consigned to the customer based on this standard deviation; and means for outputting the set expiry date rank.

In the consignment management method of the present invention for managing consignment of a product that is delivered and consigned to a customer in the field of call sales, an amount of the product consumed by each the customer and a call cycle of the customer and are input and stored; a standard deviation of an amount of the product consumed over a predetermined period by all customers is calculated from the stored amount consumed and call cycle and is then stored; an expiry date rank for the product to be consigned to the customer is set based on the stored standard deviation; the set expiry date rank is output; and a product to be consigned to a customer is decided based on the output expiry date rank.

As a result of this, by setting an expiry date rank for a product to be consigned to a customer based on the standard deviation in the amount of the product consumed over a predetermined period, and by consigning to a customer a product having an expiry date that is based on this expiry date rank, it is possible to manage product rotation consignment so that the product is efficiently consumed prior to its expiry date. The expiry date rank described here represents the frequency of use of the product by a customer.

Here, in addition to the amount of a product consumed by each customer being input directly from a personal computer or portable input/output terminal, it is also possible to input indirectly by inputting the stock of the product held by the customer and the numerical quantity to be consigned and then to transfer the amount consumed that is calculated based on these. In addition to the value of the call cycle being input directly in the same way, it is also possible to input indirectly by transferring a value generated automatically using a schedule generating device or the like.

It is preferable that the expiry date ranks are classified according to deviation values calculated based on the standard deviation. As a result of this, it is possible for all salespersons to make a judgment concerning the consignment of a product to a customer based on the expiry date rank of the relevant classification in the same way and to manage a product consignment rotation that gives more efficient consumption.

It is also possible to calculate the deviation value based on an average amount of the product consumed by all customers over the predetermined period and an average amount of the product consumed by the customer over the predetermined period. As a result of this, it is possible to manage the product consignment rotation for a particular customer based on the trend in consumption by all customers.

### BRIEF DESCRIPTION OF THE DRAWINGS

FIG. 1 is a schematic view of a business management system in the field of call sales in an embodiment of the present invention.

FIG. 2 is a block diagram showing consignment management functions of a host computer (HC) shown in FIG. 1.

FIG. 3 is a flow chart showing an example of the operation of the business management system shown in FIG. 1.

FIG. 4 is a diagram showing an example of an output to a portable input/output terminal (HT) shown in FIG. 1.

FIGS. 5(a) and 5(b) are explanatory views of conventional consignment management in the field of call sales where 5(a) shows the contents of a medicine chest before a visit by a salesperson and 5(b) shows the contents of the medicine chest after the visit by the salesperson.

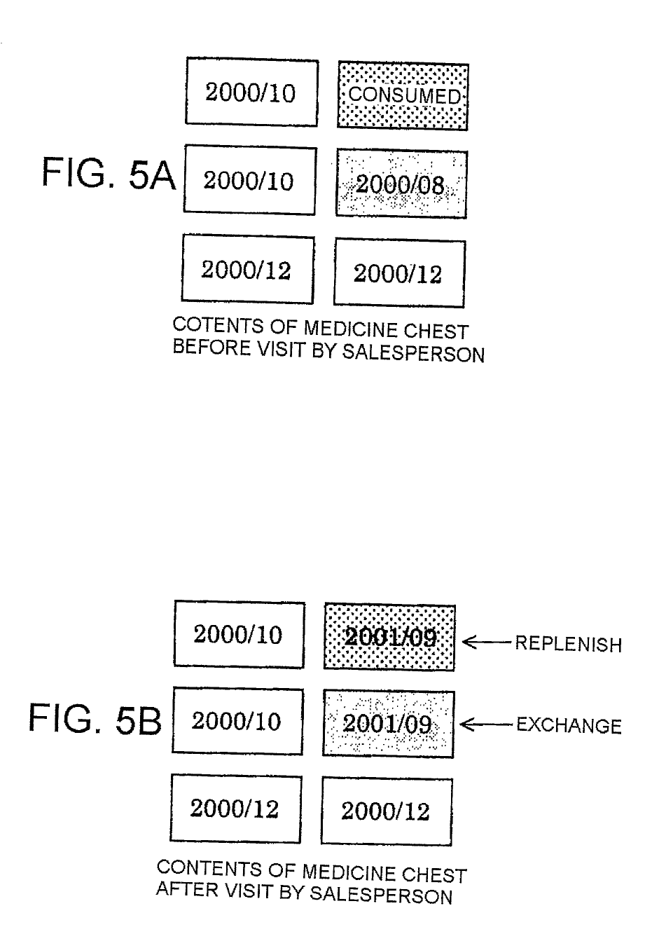

### DESCRIPTION OF THE PREFERRED EMBODIMENTS

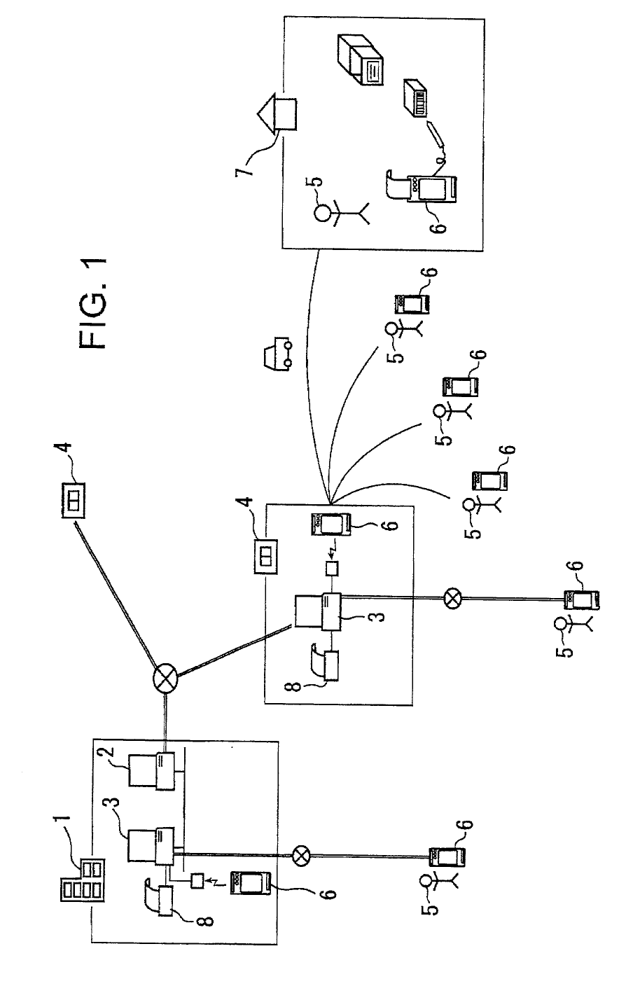

FIG. 1 is a schematic view of a business management system in the field of call sales in an embodiment of the present invention.

As is shown in FIG. 1, a host computer (referred to below as HC) 2 for data tabulation analysis and a personal computer (referred to below as “PC”) 3 connected to the host computer 2 for data communication are installed in a head office 1. The PC 3 is also installed in each sales office 4 and each sales person 5 carries a portable input/output terminal (referred to below as “HT”) 6.

The salesperson 5 inputs and records on the HT 6 all data relating to a customer 7 serving as the client such as data on the customer and data on the products consigned to that customer. Tabulation analysis is performed when the customer data and consigned product data recorded in the HT 6 are sent to the PC 3. At this time, a telephone line, infrared communication, a PC card, or the like may be used for the means of communication between the HT 6 and the PC 3, and a data file is transferred using these means.

The customer data includes an area code, the customer's name, the customer's address, the call cycle, the date of the previous call, the days when the customer stays, the times when the customer stays, a residential map page, the previous credit balance, a record of the sales, the total sales amount, the amount recovered, the current credit balance, the date of the next payment collection, the clinical history, and the like. The consigned product data includes product names, regular prices of the product, product efficacy, names of the manufacturers, selling prices, discount prices, customer stock, limits on the time the product is left with the customer, instructions of consigned product items and quantity, salesperson stock items, salesperson stock numerical quantities, limits on expiry dates, total prices, and the like.

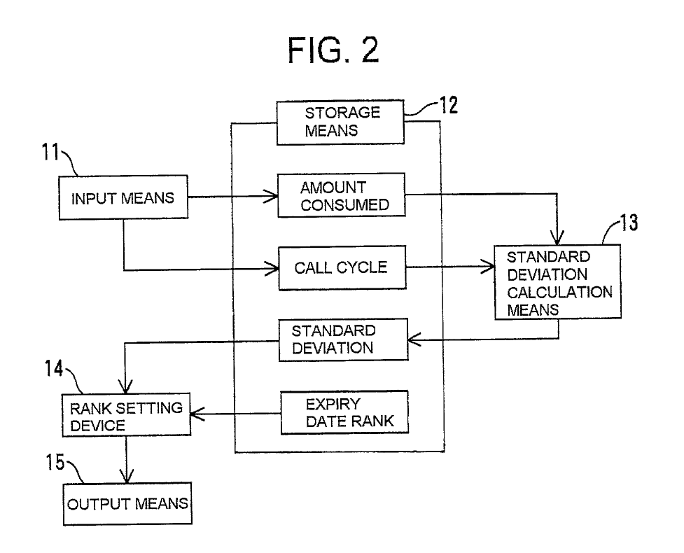

FIG. 2 is a block diagram showing consignment management functions of the HC 2 shown in FIG. 1.

In FIG. 2, the HC 2 is provided with an input means 11 for inputting tabulated data sent from the PC 3, a storage means 12 for storing inputted tabulated data, calculation results and the like, a standard deviation calculation means 13 for calculating the standard deviation in the amount of a particular product consumed over a predetermined period by all customers based on the tabulated data stored in the storage means 12, a rank setting means 14 for setting an expiry date rank for a product that is consigned to a customer based on the standard deviation stored in the storage means 12, and an output means 15 for outputting the expiry date rank and the like set by the rank setting means 14 to the PC 3, HT 6, printer 8, and the like.

The tabulated data which are input using the input means 11 and stored in the storage means 12 includes the amount of each product consumed by each customer until the salesperson calls on the customer as well as the call cycle of each customer. The standard deviation calculation means 13 calculates the standard deviation S in the amount of each product consumed by all customers upon one call by the salesperson and the calculated standard deviation S is stored in the storage means 12.

The rank setting means 14 acquires the standard deviation S from the storage means 12 and sets an expiry date rank for the product consigned to a customer based on the standard deviation S. The product expiry date rank is selected from proposed ranks which are stored in advance in the storage means 12.

More specifically, the rank setting means 14 acquires the amount of the product consumed in the past by the customer from the storage means 12, determines the average amount P consumed between the calls, with the call cycle being used as a predetermined period, for the total amount of the product consumed in the past, and further determines from the storage means 12 the average amount Q of the product consumed by all customers upon each call. Furthermore, the longest call cycle X from out of all customers as well as the call cycle Y of the customer and the standard deviation S are acquired from the storage means 12. A deviation value D is then determined using the following formula.

D=10×(P×X/Y−Q)/S+50

The proposed expiry date ranks stored in the storage means 12 are classified according to the deviation value calculated on the basis of the standard deviation S and an example thereof is shown in table 1.

TABLE 1

| | DEVIATION VALUE | DISTRIBUTION |
|---|---|---|
| EXPIRY DATE RANK | CLASSIFICATION | RATIO |
| A | 65 AND OVER | 7% |
| B | 55-64 | 24% |
| C | 45-54 | 38% |
| D | 35-44 | 24% |
| E | 34 AND UNDER | 7% |

The rank setting means 14 selects the expiry date rank that corresponds to the deviation value D determined using the above formula from among the deviation value classifications in Table 1. The expiry date rank represents the period until a customer consumes a product as a frequency of use of the product by the customer. In other words, the customers that correspond to each expiry date rank indicate in the order A, B, C, D and E the shortest period until the product is consumed. Accordingly, an instruction is given to the effect that a product having a comparatively near expiry date is consigned to a customer whose expiry date rank is close to A while a product having a comparatively distant expiry date is consigned to a customer whose expiry date rank is close to E.

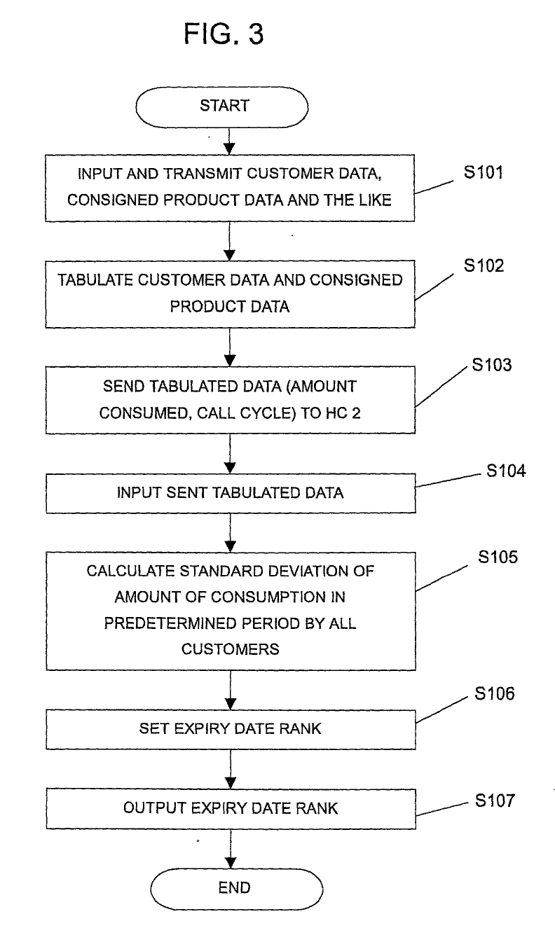

A description will now be given for the operation of the business management system having the above structure based on a flow chart shown in FIG. 3.

The salesperson 5 calls on the customer in accordance with the call cycle of each customer. When the task of calling on the customer 7 is ended, the salesperson 5 sends the customer data, consigned product data and the like which have been input into the HT 6 to the PC 3 (step S101). The day's transaction data can be transmitted from the HT 6 to the PC 3 when the salesperson 5 is out by sending data directly to the PC 3 by PC communication using a telephone line from the HT 6 carried by the salesperson 5. The customer data and product data sent to the PC are tabulated by the PC 3 (step S102) and the tabulated data is sent to the HC 2 (step S103).

The tabulated data sent from the PC 3 are input using the input means 11 and stored in the storage means 12 (step S104) H The standard deviation calculation means 13 acquires the amount of consumption and the call cycle from the tabulated data stored in the storage means 12, calculates the standard deviation S for the amount of each product consumed by all customers upon each call, and stores this in the storage means 12 (step S105).

The rank setting means 14 acquires the standard deviation S from the storage means 12 and sets the appropriate expiry date rank by comparing the deviation value D calculated on the basis of the standard deviation S with the proposed expiry date ranks that have been set in advance (S106). The set expiry date rank is then output using the output means 15 to the HT 6 or the like of the salesperson 5 (step S107) and the salesperson 5 then consigns the product to a customer based on the output expiry date rank.

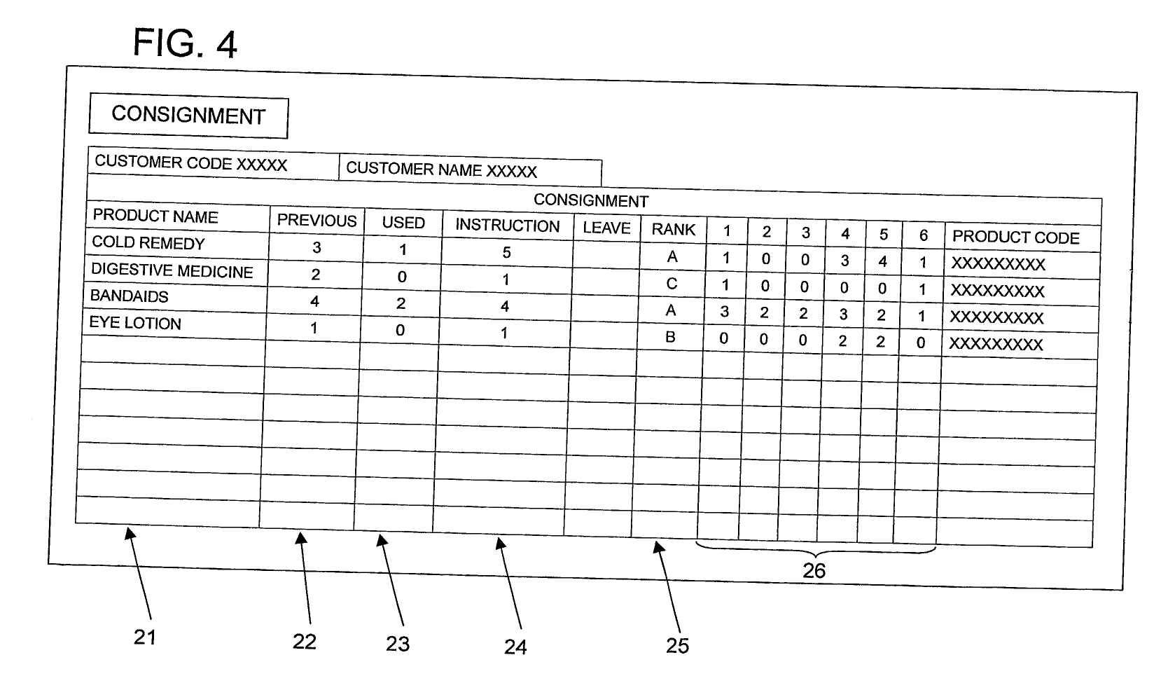

FIG. 4 shows an example of an output to the HT 6.

As is shown in FIG. 4, a product name 21, an amount consigned for the previous period 22, an amount consumed in the previous period 23, an instructed consignment amount for the current period 24, and an expiry date rank 25 for each product are displayed on the HT 6. On the right side thereof is displayed the consumed amount history 26 of each product up until two periods before.

When the salesperson 5 consigns a product to a customer based on the instructed consignment amount 24 for the current period displayed as in shown in FIG. 4, the expiry date of the consigned product is managed based on the expiry date rank 25 also displayed on the HT 6. Namely, based on the expiry date rank 25, by consigning a product having a comparatively near expiry date to a customer whose expiry date rank is close to A and by consigning a product having a comparatively distant expiry date to a customer whose expiry date rank is close to E, it is possible to consume a product efficiently prior to its expiry date.

For example, if a particular product has a maximum expiry date of 5 years, the period until the expiry date of this product is divided into 5 stages and products having remaining time of 1 to 5 years before the expiry dates are allocated to customers having respective expiry date ranks of A to E in Table 1. The result of this is that a product having a short time remaining until its expiry date is allocated to a customer who uses the product more quickly, thereby enabling the product to be consumed efficiently prior to its expiry date.

Moreover, in the present embodiment, by employing a structure in which the expiry date rank is selected from the proposed expiry date ranks which are classified according to deviation values calculated based on the standard deviation S shown in table 1, it is possible for all salespersons 5 to make a judgment concerning the consignment of a product to a customer based on the expiry date rank of the relevant classification in the same way and to obtain a product consignment rotation that gives more efficient consumption.

Furthermore, in the present embodiment, by employing a structure in which a deviation value is calculated based on the average amount of a product consumed by all customers over a predetermined period as well as the average amount of the product consumed by one customer over a predetermined period, it is possible to obtain a product consignment rotation that gives even more efficient consumption by using the expiry date rank that has been set for one customer based on the trend in consumption by all customers.

While the preferred form of the present invention has been described, it is to be understood that modifications will be apparent to those skilled in the art without departing from the spirit of the invention. The scope of the invention, therefore, is to be determined solely by the following claims.

What is claimed is:

1. A consignment management device for managing consignment of a product that is delivered and consigned to a customer in the field of call sales comprising:
means for inputting an amount of product consumed by the customer and a call cycle of the customer;
first storage means for storing the input consumed amount;
second storage means for storing the input call cycle;
means for acquiring both the consumed amount from the first storage means and the call cycle from the second storage means and calculating a standard deviation of an amount of the product consumed over a predetermined period by all customers;
third storage means for storing the calculated standard deviation;
means for acquiring the standard deviation from the third storage means and setting an expiry date rank for the product to be consigned to the customer based on the standard deviation; and
means for outputting the set expiry date rank.

2. The consignment management device according to claim 1, wherein the expiry date ranks are classified according to deviation values calculated based on the standard deviation.

3. The consignment management device according to claim 2, wherein the deviation values are calculated based on an average amount of the product consumed by all customers over the predetermined period and an average amount of the product consumed by the customer over the predetermined period.

4. A consignment management method for managing consignment of a product that is delivered and consigned to a customer in the field of call sales, wherein:
an amount of the product consumed by the customer and a call cycle of the customer are input and stored;
a standard deviation of an amount of the product consumed over a predetermined period by all customers is calculated from the stored amount consumed and call cycle and is then stored;
an expiry date rank for the product to be consigned to the customer is set based on the stored standard deviation;
the set expiry date is output; and
a product to be consigned to a customer is decided based on the output expiry date rank.
